(19) United States
(12) Patent Application Publication
(10) Pub. No.: US 2015/0001322 A1
(43) Pub. Date: Jan. 1, 2015

(54) METHOD FOR DISPERSING FILLER, AND MICRO-DISPERSING MIXER

(71) Applicant: Panasonic Corporation, Osaka (JP)

(72) Inventor: Masaki Sato, Fukushima (JP)

(73) Assignee: Panasonic Corporation, Osaka (JP)

(21) Appl. No.: 14/375,010

(22) PCT Filed: Jan. 15, 2013
(86) PCT No.: PCT/JP2013/000127

§ 371 Date: Jul. 28, 2014

(30) Foreign Application Priority Data
Feb. 17, 2012 (JP) 2012-032542

(51) Int. Cl. C08J 3/22; B29B 7/74; C08K 3/04; B29B 7/00

(52) U.S. Cl. CPC C08J 3/22; B29B 7/002; B29B 7/7476; C08K 3/04; C08J 2300/22; C08J 2300/26; C08J 2300/12
USPC 241/1; 241/291; 523/351; 523/468; 524/611; 524/612; 524/556

(57) ABSTRACT

A method for dispersing a filler having high agglomerating properties in a resin and a micro-dispersing mixer used in the method are provided. Further, a method for producing a sealing material that can avoid a defect caused by agglomerates of a filler (for example, carbon black) in an electronic material such as a semiconductor package, a masterbatch resin produced by the method, and a micro-dispersing mixer used in the method are provided. When a filler is dispersed in a molten resin composition to produce a filler-dispersed molten resin composition, a resin composition containing filler aggregates and a molten resin composition is preliminarily mixed by a mixing means, and, thereafter, the preliminarily mixed mixture is allowed to pass through the micro-dispersing mixer with a fine flow path to disperse the filler in a filler resin composition.

### TECHNICAL FIELD

The present invention relates to a method for dispersing a filler, and a micro-dispersing mixer. The method and the micro-dispersing mixer disperse fillers with high agglomerating properties, such as carbon black, in a resin.

### BACKGROUND ART

In recent years, semiconductor packages have been strongly required to achieve high functionalization, miniaturization, densification, reduction in weight and reduction in profile. Measures for the requirements are diversified according to the needs.

There is one trend that a wiring interval between micropatterned wirings is further narrowed to achieve high-density integration. Although a wiring interval is on the order of 75 μm at present, in the future, the wiring interval is expected to be 40 μm or less.

An epoxy resin composition is used as a sealing material for protecting a semiconductor element. Carbon black serving as a coloring agent is added to the semiconductor sealing material (epoxy resin composition) to impart light shielding properties and laser marking properties. However, the carbon black has conductivity. Thus, agglomerates of carbon black stuck in between the wirings whose interval is narrowed may cause an electric defect.

Although depending on production methods, a primary particle diameter of the carbon black ranges from approximately 10 to 100 nm. A large number of primary particles are gathered to form a primary aggregate having several micrometers. Since the primary aggregate is generated with very high energy in production processes, the primary aggregate is considered as a minimum unit of carbon black that cannot be ground any more. Furthermore, carbon material such as carbon black tends to easily form agglomerates in the processes, including packaging, storing, and conveying, which results in formation of some secondary agglomerates on the order of 100 to 1000 μm.

The epoxy resin composition serving as the semiconductor sealing material comprises an epoxy resin, a phenol resin, a curing agent, an inorganic filler, a mold release agent, a coloring agent, a coupling agent, and the like. In general, predetermined amounts of raw materials are measured and collected, and then mixed together by use of a powder mixer or a grinder. The mixture is melt-kneaded with a thermal kneading machine or a rolling machine, thereby uniformly dispersing the raw materials.

With the above method, almost all secondary agglomerates of carbon black serving as a coloring agent are crushed and dispersed in the epoxy resin composition. When a wiring interval was 75 μm, a short-circuit defect of wirings caused by carbon black was rarely observed. However, when the wiring interval is 45 μm, agglomerates of carbon black may cause a short-circuit defect to pose a critical problem.

For this reason, Patent Document 1 mentions the problem mentioned above and proposes the use of carbon black having a particle diameter of smaller than 25 μm, and exemplifies a method for obtaining such carbon black, which involves grinding carbon black with a grinding machine, such as a jet mill, and classifying particles with a classification filter, a cyclone classifier, or the like.

Patent Document 2 mentions the problem mentioned above and proposes the use of oxidized carbon black in which a dibutyl phthalate (DBP) absorption amount, a primary particle diameter, and a nitrogen adsorption specific surface area are regulated as the physical properties of carbon black.

In Patent Document 3, black titanium oxide having low conductivity is used as a coloring agent to avoid an electric defect.

Furthermore, Patent Document 4 proposes that black titanium oxide and an epoxy resin are masterbatched to moderate aggregation of a coloring agent. In a method for dispersing a coloring agent, a device with an impeller is adapted to disperse the coloring agent by using bead media.

Patent Document 5 discloses a method for refining carbon black with an airflow grinder, but does not mention prevention of re-agglomeration.

### PRIOR ART DOCUMENTS

### Patent Documents

Patent Document 1: JP 2008-121010 A
Patent Document 2: JP 4381447 B1
Patent Document 3: JP 4483655 B1
Patent Document 4: JP 3367947 B1
Patent Document 5: JP 2005-120277 A

### DISCLOSURE OF THE INVENTION

### Problem to be Solved by the Invention

Methods of crushing filler agglomerates, which have been hitherto proposed, include a method using a strong collision force as disclosed in Patent Documents 1 and 5, and a method using a combination of a strong shearing force and a strong collision force as shown in Patent Document 4.

An airflow grinder, such as a jet mill, disclosed in Patent Documents 1 and 5 jets agglomerates together with a high-speed air flow from a nozzle to cause ejections to run against a wall or run against each other so as to refine the agglomerates. However, in this case, although the agglomerates are temporarily refined, a carbon filler, which is likely to form agglomerates, disadvantageously gradually re-agglutinate over time.

In a bead mill grinding and mixing machine disclosed in Patent Document 4, inactive bead particles and an object to be ground are put in a device with an impeller, and stirred to refine the object with an interaction between shearing caused by stirring and collision made by the beads. However, when a high-viscosity fluid such as an epoxy resin is used, disadvantageously, the inactive beads are very difficult to separate from the fluid.

In addition, as a general approach, a means for giving a strong shearing force in melt-kneading and a method for performing melt-kneading for a long period of time are tried. However, these approaches cannot derive a fundamental solution.

As mentioned above, the conventional crushing method for filler agglomerates requires a large-scale device, such as a jet mill or a bead mill, and a high energy so as to use an impulsive force and a shearing force.

The present invention has been made in consideration of the above problems, and it is an object of the present invention to provide a method for dispersing a filler having high agglomerating properties in a resin, and a micro-dispersing mixer used in the method. Furthermore, it is another object of the present invention to provide a method for producing a sealing material that can avoid a defect of an electronic material, such as a semiconductor package, due to filler agglomerates; a masterbatch produced by the method; and a micro-dispersing mixer used in the method.

### Means for Solving the Problem

As a result of intensive study to solve the above problems, the present inventors have found that a resin composition containing filler agglomerates and a resin is preliminarily mixed by a mixing unit, and thereafter, a preliminarily mixed mixture is caused to pass through a micro-dispersing mixer having a micro flow path to break the filler agglomerates and to disperse the fillers in the resin composition so as to avoid a defect caused by filler agglomerates in an electronic material, such as a semiconductor package. Thus, the present invention has been made.

Accordingly, the present invention provides a method for producing a filler-dispersed molten resin composition by dispersing a filler in a molten resin composition, the method including the steps of:

preliminarily mixing a resin composition by mixing unit, the resin composition containing filer aggregates and molten resin composition; and

allowing a preliminarily mixed mixture to pass through a micro-dispersing mixer having a fine flow path to break the filler aggregates and to disperse the filler in the resin composition.

In the present invention, since the resin composition is caused to pass through the micro-dispersing mixer, the filler with high agglomerating properties, such as carbon black, can be uniformly dispersed in the resin composition. In addition, since the resin composition is preliminarily mixed by the mixing unit before the resin composition passes through the micro-dispersing mixer, the resin composition can be efficiently broken without clogging in the micro-dispersing mixer. The term “breaking” as used in the present invention means that agglomerates or aggregates are dispersed.

In the method for producing a filler-dispersed molten resin composition according to the present invention, the filler is preferably at least one selected from the group consisting of carbon black and carbon nanotube.

In the method for producing a filler-dispersed molten resin composition according to the present invention, the resin is preferably a thermosetting resin in a state before being cured.

The thermosetting resin is preferably at least one selected from the group consisting of an epoxy resin, a phenol resin, a melamine resin, a urea resin, an unsaturated polyester resin and a thermosetting elastomer.

In the method for producing a filler-dispersed molten resin composition according to another aspect of the present invention, the molten resin is at least one selected from the group consisting of a thermoplastic resin and a thermoplastic elastomer.

The present invention is a filler-dispersed masterbatch resin produced by cooling and solidifying the filler-dispersed molten resin composition prepared by the above-mentioned method for producing a filler-dispersed molten resin composition.

Furthermore, the present invention also provides a method for producing a filler-dispersed masterbatch resin including a filler and a resin by cooling and solidifying the filler-dispersed molten resin composition prepared by the method mentioned above.

The present invention provides a method for producing a sealing resin composition produced by supplying the filler-dispersed molten resin composition produced by the above-mentioned method or using the filler-dispersed masterbatch resin produced by the above-mentioned method for producing a filler-dispersed masterbatch resin.

The present invention provides a micro-dispersing mixer for dispersing a filler in a molten resin composition. The micro-dispersing mixer includes: a main flow path allowing a mixture including the filler and the molten resin composition to pass through the main flow path; and a micro-mixing unit disposed in the main flow path, the micro-mixing unit having at least one fine flow path, and adapted to break filler aggregates. The mixture is allowed to pass through the fine flow path.

The micro-dispersing mixer according to the present invention further includes a sub-flow path having a suction port and a discharge port communicating with the suction port, the suction port being disposed near an upstream of the micro-mixing unit, and the discharge port being in fluid communication with the main flow path on an upstream side of the main flow path with respect to the suction port. A part of the mixture is allowed to flow through the fine flow path, and a residual part of the mixture is refluxed to the upstream of the main flow path through the sub-flow path. In the micro-dispersing mixer according to the present invention, the sub-flow path has the suction port and the discharge port communicating with the suction port, the suction port is formed near the upstream side of the micro-mixing unit, and the discharge port is connected to the main flow path on the upstream side of the main flow path with respect to the suction port. For this reason, filler aggregates that do not pass through the micro-mixing unit can be circulated to the micro-mixing unit again, which can increase a dispersion efficiency of the filler, while preventing clogging of the fillers.

The micro-dispersing mixer according to the present invention may further include a suction unit disposed on a downstream of the micro-mixing unit in the main flow path, the suction unit being adapted to suck the molten resin composition, or a pressurizing unit disposed on the upstream of the micro-mixing unit in the main flow path, the pressurizing unit being adapted to pressure the molten resin composition, or both the suction unit and pressurizing unit.

In one aspect of the micro-dispersing mixer according to the present invention, the suction unit is a penetration path disposed in the main flow path to penetrate the micro-mixing unit in substantially parallel with the main flow path, and a downstream side opening end of the penetration path is located on the upstream side of the main flow path with respect to the downstream side opening end of the main flow path.

In the micro-dispersing mixer according to the present invention, the main flow path further includes a projection extending from an inner wall of the main flow path toward a center thereof so as to go around the inner wall.

The present invention is a micro-dispersing system including: the above-mentioned micro-dispersing mixer; and a stirring tank connected to an upstream opening end of the main flow path. The stirring tank includes a stirring unit for stirring a molten resin composition in the stirring tank and conveying the molten resin composition to the micro-mixing unit in the main flow path.

In the micro-dispersing system according to the present invention, the stirring tank may further include a convection passage disposed near an inlet of the main flow path. The term “convection passage” as used herein means a passage where convection occurs. An external power or a convective effect of the molten resin composition itself in the convection passage causes the convection in the convection passage.

According to another aspect of the present invention, the micro-dispersing system may further include a kneading unit disposed on the upstream of the main flow path.

In the micro-dispersing system according to the present invention, the kneading unit may be a screw extruding kneader, a batch internal mixer, or a continuous single or twin screw extruding kneader.

### Effect of the Invention

Accordingly, the present invention can provide a method for producing a filler-dispersed molten resin composition, a filler-dispersed masterbatch resin, a method for producing a filler-dispersed masterbatch resin, a method for producing a semiconductor sealing resin composition, a micro-dispersing mixer, and a micro-dispersing system that avoid a defect caused by filler agglomerates in an electronic material such as a semiconductor package.

### BRIEF DESCRIPTION OF THE DRAWINGS

FIG. 1 is a schematic cross-sectional view of a micro-dispersing mixer according to a first embodiment of the invention.

FIG. 2 is a schematic cross-sectional view of a fine flow path included in a micro-mixing unit of the micro-dispersing mixer according to the first embodiment.

FIGS. 3A to 3C are schematic views showing the shape and pattern of the fine flow path in the micro-dispersing mixer according to the first embodiment.

FIG. 4 is a cross-sectional view of the micro-dispersing mixer according to another aspect of the first embodiment.

FIG. 5 is a sectional view of one aspect of a micro-dispersing mixer according to a second embodiment of the invention.

FIG. 6 is a schematic view of the micro-dispersing mixer according to another aspect of the second embodiment.

FIG. 7 is a schematic cross-sectional view of the micro-dispersing mixer according to still another aspect of the second embodiment.

FIG. 8 is a schematic cross-sectional view of a micro-dispersing system according to a third embodiment of the invention.

FIG. 9 is a schematic view of a stirring-tank-type pressure micro-dispersing system according to one aspect of a fourth embodiment of the invention.

FIG. 10 is a schematic view of an extruding-kneader-type pressure micro-dispersing system according to another aspect of the fourth embodiment.

FIG. 11 is a schematic view of a stirring-tank-type suction micro-dispersing system according to one aspect of a fifth embodiment of the invention.

FIG. 12 is a schematic view of an extruding-kneader-type suction micro-dispersing system according to another aspect of the fifth embodiment.

FIG. 13 is a schematic view of a stirring-tank-type self-suction micro-dispersing system according to one aspect of a sixth embodiment of the invention.

FIG. 14 is a schematic cross-sectional view of a micro-dispersing mixer having a central penetration path.

FIG. 15 is a schematic view of a stirring-tank-type self-suction micro-dispersing system according to another aspect of the sixth embodiment.

FIG. 16A is an upper view of a micro-dispersing mixer used in the micro-dispersing system according to the above-mentioned aspect, and FIG. 16B is a cross-sectional view of the micro-dispersing mixer.

FIG. 17 is a schematic view of a stirring-tank-type self-suction micro-dispersing system according to still another aspect of the sixth embodiment.

FIG. 18A is an upper view of a micro-dispersing mixer used in the micro-dispersing system according to still another aspect, and FIG. 18B is a cross-sectional view thereof.

FIG. 19 is a schematic view of a system used in micro-dispersion.

FIG. 20 is an exploded perspective view of a micro-dispersing mixer.

FIGS. 21A to 21C are schematic views of fine flow path plates included in the micro-dispersing mixer.

### MODES FOR CARRYING OUT THE INVENTION

Preferred embodiments for carrying out the present invention will be described in detail with reference to the accompanying drawings. However, the embodiments mentioned below exemplify a method for producing a filler-dispersed molten resin composition, a micro-dispersing mixer, a micro-dispersing system, and the like to embody the technical idea of the present invention, and do not limit the scope of the present invention. The sizes, materials, shapes, relative arrangements, and the like of components mentioned in the embodiments, unless otherwise noted, are not intended to limit the scope of the invention only thereto, and are illustrative only. The sizes, positional relationships, and the like of members shown in the drawings may be exaggerated to clarify the explanation.

A filler is made of carbon black and/or carbon nanotube. However, the filler is not limited to these materials, and may be another material having high agglomerating properties. A material having a particle diameter of several tens of micrometers (several 10 μm) or less has high agglomerating properties. For example, inorganic nano particles or the like may frequently form aggregates. The present invention is used to disperse aggregates of such fine particles in a resin.

### First Embodiment

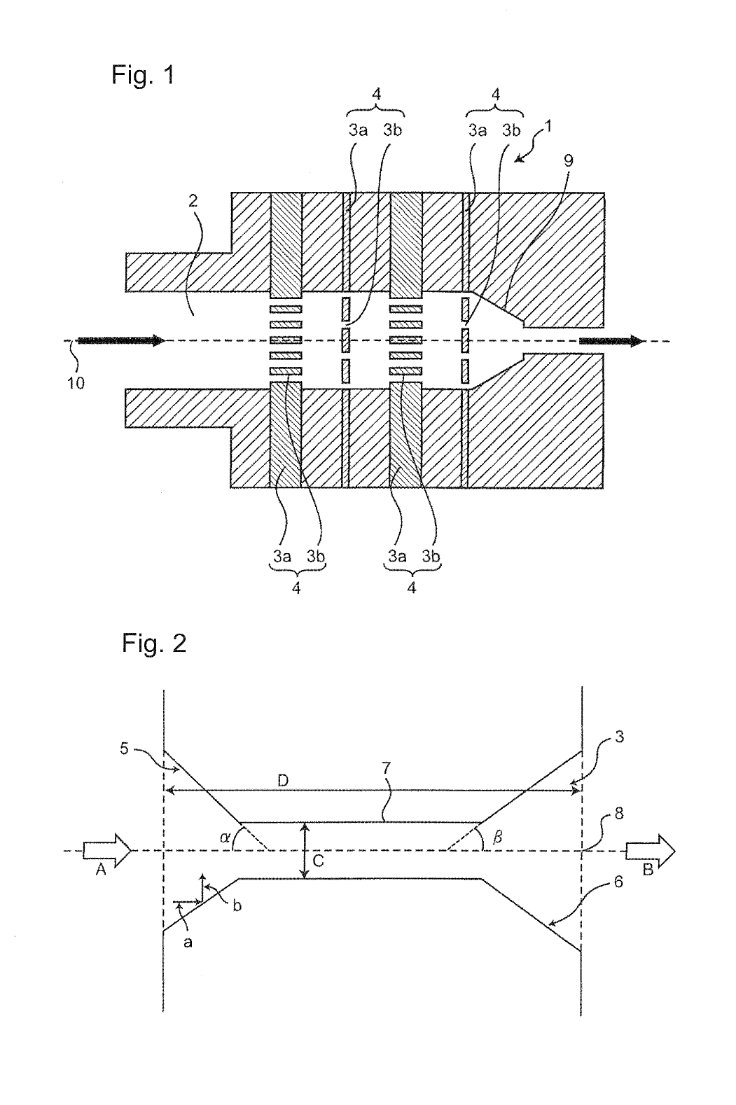

FIG. 1 is a schematic cross-sectional view of a micro-dispersing mixer 1 according to a first embodiment of the invention. As shown in FIG. 1, the micro-dispersing mixer 1 in the first embodiment includes a main flow path 2 through which a molten resin composition containing a filler and a molten resin passes, and a micro-mixing unit 4 disposed in the main flow path 2.

As shown in FIG. 1, the micro-mixing unit 4 is formed of a plate-like member 3a. The plate-like member 3a is formed such that a plurality of fine flow paths 3b penetrates the plate-like member 3a from one major surface to the other main surface thereof. A molten resin composition containing the filler and the molten resin is allowed to pass through the fine flow paths 3b, whereby secondary aggregates of the filler (for example, carbon black) receive stress from the inner walls of the fine flow paths 3b, and the stress can act on weak-bonding parts of the secondary aggregates to break the secondary aggregates, thereby dispersing primary aggregates into the molten resin composition.

In the micro-dispersing mixer 1 of the first embodiment, the four micro-mixing units 4 are disposed in the main flow path 2. However, the number of micro-mixing units 4 is not limited to four, and any number of micro-mixing units 4 may be disposed as long as the secondary aggregates can be broken.

In the micro-dispersing mixer 1 of the first embodiment, the micro-mixing units 4 are preferably formed across the entire area of a flow path section of the main flow path 2. Accordingly, the filler aggregates in the molten resin composition can be sufficiently broken. However, as long as a sufficient dispersive power can be obtained, the micro-mixing units 4 may be disposed on a part of the flow path section of the main flow path 2 to close one part of the flow path section and to open the other part.

FIG. 2 is a schematic cross-sectional view of the fine flow paths 3b included in the micro-mixing unit 4 of the micro-dispersing mixer 1 in the first embodiment. As shown in FIG. 2, each of the fine flow paths 3b has a contraction flow part 5 formed at the suction port of the fine flow path 3b, an elongation flow part 6 disposed as the discharge port of the fine flow path 3b, and an extending flow part 7 disposed between the contraction flow part 5 and the enlargement flow part 6. The contraction flow part 5 is disposed to be reduced in diameter from an upstream A toward a downstream B. On the other hand, the enlargement flow part 6 is disposed to be increased in diameter from the upstream A toward the downstream B. In this manner, a flow resistance generated when the resin composition is caused to flow in the fine flow paths 3b is reduced, and stress a toward the downstream B is converted into stress b toward the center of a central axis 8 in the longitudinal direction, so that the stress b toward the center can effectively break the aggregates.

An angle α (an angle between a negative direction of a longitudinal axis 8 and a line configuring the contraction flow part 5 on a section including the longitudinal direction 8 of the fine flow paths 3b) is not specifically limited. However, on the section including the longitudinal axis 8 of the fine flow paths 3b, the angle between the contraction flow part 5 and the longitudinal axis 8 preferably ranges from 15 to 60°. When the angle α of the contraction flow part 5 falls within such a range, a flow resistance generated when the molten resin component including the filler and the molten resin passes through the fine flow paths 3b can be effectively reduced, while the filler aggregates can be effectively broken.

In the micro-dispersing mixer 1 in the first embodiment, a width C of the fine flow path 3b is not limited to a specific value. However, the width C preferably ranges from 50 μm to 10 mm, and more preferably, from 100 μm to 3 mm. When the width C of the fine flow path 3b falls within the range, the filler aggregates can be effectively broken by stress generated by the inner wall of the fine flow path 3b, and dispersed in the molten resin to make it possible to increase the dispersive power of the filler. Since the dispersing effect increases as a linear flow rate of a fluid passing through the fine flow path 3b is increased, the width C is preferably set depending on a required throughput. When the width C decreases, the dispersive effect increases, while the fillers are more likely to be clogged. For this reason, the width C is preferably set depending on the content of the filler, the average diameter of the filler, and the like.

In the micro-dispersing mixer 1 of the first embodiment, although a flow path length D of the fine flow path 3b is not specifically limited, the flow path length D preferably ranges from 1 mm to 100 mm. When the flow path length D of the fine flow path 3b falls within the range, filler aggregates can be effectively dispersed by an elongation motion in the fine flow path 3b to make it possible to increase the filler dispersive power. As the flow path length D increases, the dispersing effect becomes greater, and, in contrast, a pressure loss is increased. For this reason, the flow path length D is preferably set depending on the required throughput and the pressure loss.

Turning back to FIG. 1, the micro-dispersing mixer 1 according to the first embodiment will be mentioned below. The main flow path 2 of the micro-dispersing mixer 1, as shown in FIG. 1, is preferably reduced in diameter on a downstream side 9. On the section including a longitudinal axis 10 of the main flow path 2, the plane of the main flow path 2 on the downstream side 9 is formed to be obliquely tilted. For this reason, the plane of the main flow path 2 on the downstream side 9 converts stress acting from the upstream of the main flow path 2 to the downstream thereof into stress toward the center of the longitudinal axis 10 of the main flow path 2, and the stress toward the center assists in breaking the filler aggregates.

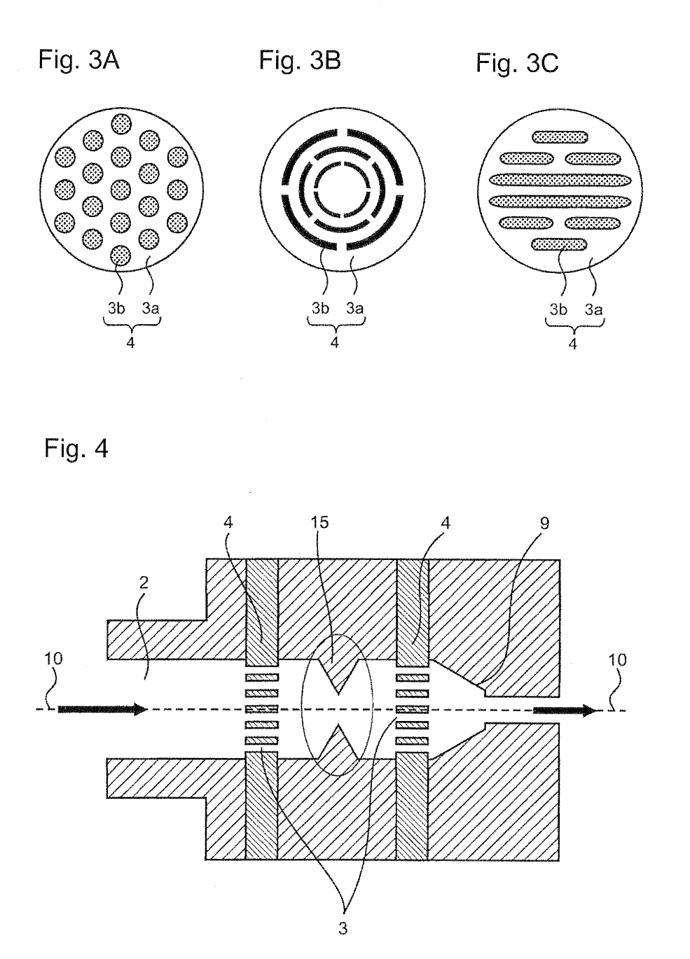

FIGS. 3A to 3C show the shapes and the patterns of the fine flow paths 3b of the micro-dispersing mixer 1 in the first embodiment. The fine flow paths 3b may have any shape and pattern as long as the filler aggregates can be broken. As shown in FIG. 3A, the fine flow paths 3b each having a circular sectional shape may be patterned in the form of a hexagon. Alternatively, as shown in FIG. 3B, the ring-shaped narrow fine flow paths 3b may be patterned concentrically. Alternatively, as shown in FIG. 3C, the rod-like narrow fine flow paths 3b are patterned to be in parallel with each other.

FIG. 4 is a cross-sectional view of the section of a projection 15 including the longitudinal axis 10, the projection 15 being disposed on the inner wall of the main flow path 2 of the micro-dispersing mixer 1 in the first embodiment. The projection 15 goes around the inner wall of the main flow path 2 and, as shown in FIG. 4, projects from the inner wall of the main flow path 2 toward the longitudinal axis 10 (center of the main flow path 2). Although the projection 15 has any sectional shape, as shown in FIG. 4, the projection 15 may have a triangular sectional shape with the interval of sides thereof decreasing from the inner wall of the main flow path 2 toward the center, or may have a trapezoidal sectional shape with the interval of sides thereof decreasing from the inner wall toward the center. In this manner, as mentioned above, the plane of the projection 15 converts stress acting from the upstream of the main flow path 2 toward the downstream thereof into stress acting toward the longitudinal axis 10 of the main flow path 2, and the stress accelerates breaking.

According to the micro-dispersing mixer 1 of the first embodiment, since the micro-mixing unit 4 having the fine flow paths 3b is formed in the main flow path 2, a molten resin composition containing a filler and a molten resin is caused to pass through the fine flow paths 3 to elongate and break filler aggregates in the fine flow paths 3b, so that the filler aggregates can be mixed and widely dispersed in the molten resin.

### Second Embodiment

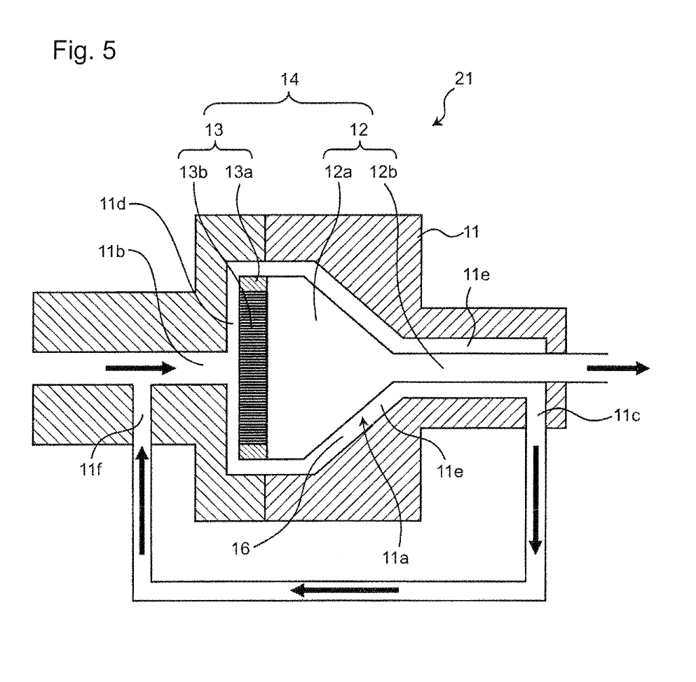

FIG. 5 is a schematic view of a micro-dispersing mixer 21 according to a second embodiment. As shown in FIG. 5, the micro-dispersing mixer 21 of the second embodiment includes a first housing 11 having a cavity portion 11a, and a second housing 14 disposed in the cavity portion 11a. The second housing 14 includes a micro-mixing unit 13, and a mixing and dispersing unit 12 which has an enlarged portion 12a coupled to the micro-mixing unit 13 and having a large sectional area, and a discharge path 12b having a sectional area that gradually decreases backward.

In the micro-dispersing mixer 21 according to the second embodiment, the micro-mixing unit 13 includes a plate-like member 13a that is formed such that a plurality of fine flow paths 13b penetrate the plate-like member 13a from one major surface to the other major surface thereof. The outer shape of the plate-like member 13a is machined to have the same shape as that of an opening of the enlarged portion 12a, and the micro-mixing unit 13 is fitted into the opening end of the enlarged portion 12a. The plate-like member 13a needs not have a plate-like shape, and may have such a curved shape that protrudes toward the upstream side. With this arrangement, the filler aggregates can be effectively broken.

The outer wall of the second housing 14 and the inner wall of the first housing 11 are disposed to be close to each other, and a flow path 11e is formed between the outer wall of the second housing 14 and the inner wall of the first housing 11. In the aspect of the second embodiment, a sub-flow path corresponds to a flow path including the flow path 11e formed between the outer wall of the second housing 14 and the inner wall of the first housing 11 and flow paths 11c and 11f that leads to the flow path 11e to communicate with a flow passage 11b on the upstream side of the micro-mixing unit 13.

In the second embodiment, the main flow path corresponds to a flow path including the enlarged portion 12a of the second housing 12, the discharge path 12b leading to the enlarged portion 12a, and the flow path 11b on the upstream side of the micro-mixing unit 13.

The downstream side of the sub-flow path 16 is merged into the flow path 11b on the upstream of the micro-mixing unit 13. More specifically, the sub-flow path 16 has a suction port 11d and a discharge port 11f communicating with the suction port 11d through the flow path 11e and the flow path 11c. The suction port 11d is disposed near the upstream of the micro-mixing unit 13. The discharge port 11f is in fluid communication with the main flow path 2 (flow path 11b) on the upstream side of the suction port 11d. As mentioned above, the sub-flow path 16 has the suction port 11d and the discharge port 11f communicating with the suction port 11d. The suction port 11d is disposed near the upstream side of the micro-mixing unit 13. The discharge port 11f is in fluid communication with the main flow path 2 (flow path 11b) on the upstream side with respect to the suction port 11d. For this reason, since the filler aggregates that are not broken without passing through the micro-mixing unit 13 are circulated through the sub-flow path 16 without being delayed and serve to be broken in the micro-mixing unit 13 again, the filler can be dispersed in the molten resin while preventing clogging caused by the aggregates.

According to the micro-dispersing mixer 21 of the second embodiment, the filler aggregates that do not pass through the micro-mixing unit 13 are circulated through the sub-flow path 16 and serve to be broken in the micro-mixing unit 13 again. For this reason, the filler can be dispersed in the resin while preventing clogging by the aggregates.

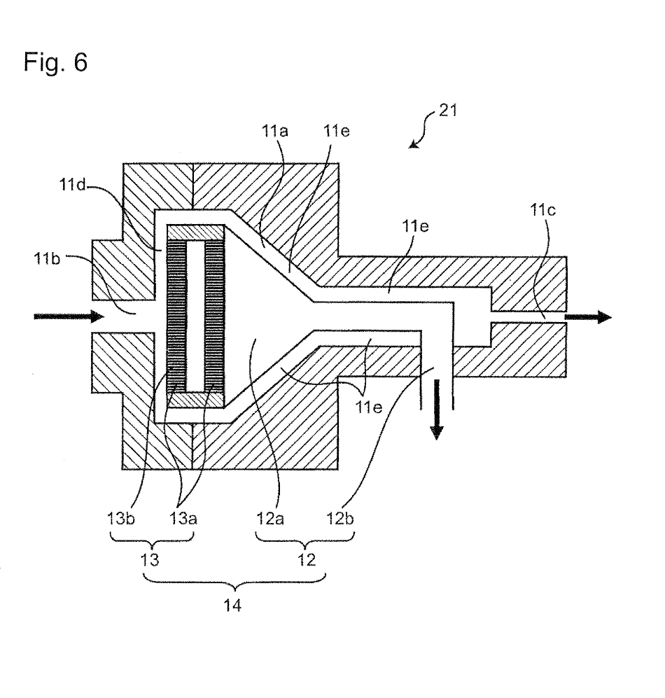

In another aspect, as shown in FIG. 6, the two micro-mixing units 13 may be disposed in parallel on the upstream side and the downstream side, respectively. The three or more micro-mixing units 13 may be disposed. This can increase the possibility of breaking filler aggregates to improve a dispersive power of the filler.

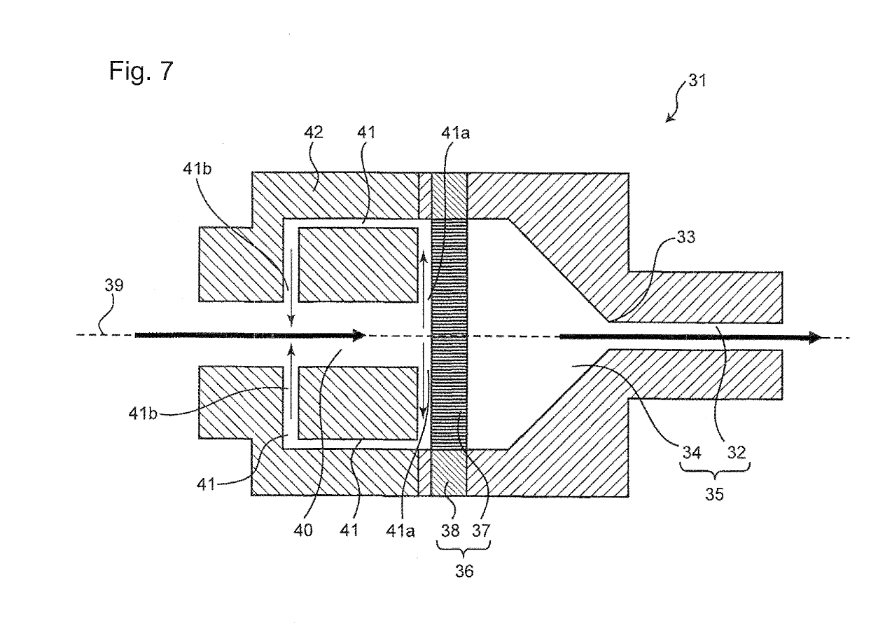

In another aspect, as shown in FIG. 7, a micro-dispersing mixer 31 includes a micro-mixing unit 36, and a mixing and dispersing unit 35 which has an enlarged portion 34 coupled to the micro-mixing unit 36 and a discharge path 32 coupled to the enlarged portion 34 to have a sectional area gradually reduced toward the enlarged portion.

In the micro-dispersing mixer 31 in this embodiment, the micro-mixing unit 36 is configured by a plate-like member 38 with a plurality of fine flow paths 37 penetrating the plate-like member 38 from one major surface to the other major surface thereof, and the micro-mixing unit 36 is attached to the opening end of the enlarged portion 34. A housing 42 is disposed on the upstream side of the plate-like member 38. The plate-like member 38 does not need to have a plate-like shape, and may have a curved shape protruding toward the upstream side. With this arrangement, the filler aggregates can be effectively broken. The housing 42 has a flow path 40 disposed near a longitudinal central axis 39 of the micro-dispersing mixer 31 and a sub-flow path 41 branched from the downstream end of the flow path 40 to circulate the filler to the upstream of the flow path 40 again. The sub-flow path 41 is branched from the downstream end of the flow path 40, widened outside the micro-mixing unit 36 along the micro-mixing unit 36. Thereafter, the sub-flow path 41 returns to the rear (upstream) side of the flow path 40 and is in fluid communication with the flow path 40 on the upstream side of the flow path 40. In this manner, filler aggregates that cannot pass through the micro-mixing unit 36 are circulated and conveyed to the micro-mixing unit 36 again to increase the possibility of causing the filler aggregates to pass through the micro-mixing unit 36, which increases a dispersive power of the filler. In the second embodiment, the main flow path 2 corresponds to a flow path including the flow path 40 that is disposed on the upstream side of the micro-mixing unit 36 and near the longitudinal central axis 39 of the micro-dispersing mixer 31, an enlarged portion 34 on the downstream side of the micro-mixing unit 36, and the discharge path 32 leading to the enlarged portion 34. The sub-flow path 41 has a suction port 41a and a discharge port 41b communicating with the suction port 41a. The suction port 41a is disposed near the upstream of the micro-mixing unit 36, and the discharge port 41b connected to the suction port 41a is connected to the main flow path 2 (flow path 40) on the upstream side of the suction port 41a.

In the micro-dispersing mixer 31 according to the second embodiment, some fillers that agglutinate without passing through the micro-mixing unit 36 circulate via the sub-flow path 41, and then are broken again by the micro-mixing portion 36, which can improve the dispersive power of the filler, while producing the micro-dispersing mixer at low cost because the shape of the sub-flow path 41 has a relatively simple shape.

### Third Embodiment

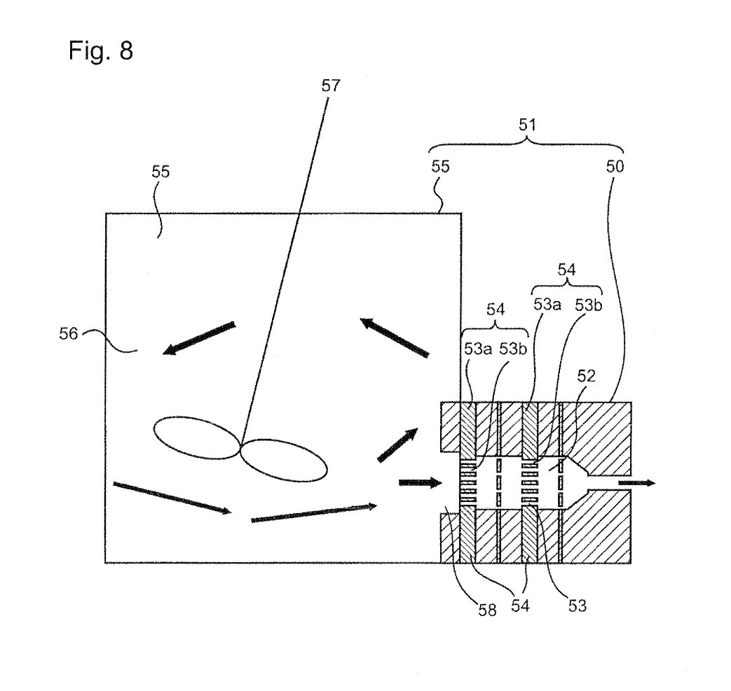

FIG. 8 is a schematic cross-sectional view of a micro-dispersing system 51 according to a third embodiment. The micro-dispersing system 51 includes a micro-dispersing mixer 50 and a stirring tank 55 connected to the micro-dispersing mixer 50.

In the micro-dispersing system 51 of the third embodiment, the micro-dispersing mixer 50 includes a main flow path 52 and four mixing units 54 disposed in the main flow path 52, and the stirring tank 55 is connected to an upstream side opening end 58 of the main flow path 52. A stirring means 57 is disposed in the stirring tank 55, and the stirring means 57 preliminarily mixes the molten resin composition containing the filler and the resin in the stirring tank 55. The molten resin composition passes through the micro-dispersing mixer 50 to make it possible to disperse filler agglomerates. In the stirring tank 55, the molten resin composition is mixed and stirred apparently substantially uniformly by convection. The molten resin composition containing the filler and the resin is conveyed while being sucked by a suction means (for example, a pump or the like) (not shown) disposed on the downstream side of the micro-dispersing mixer. The micro-dispersing mixer 50 is preferably attached to the side surface of the stirring tank 55. If the micro-dispersing mixer 50 is attached to the lower surface of the stirring tank 55, clogging may occur in the micro-dispersing mixer 50 due to the influence of an impurity or the like. The micro-dispersing mixer 50 is attached to the side surface of the stirring tank 55 to make it possible to prevent the micro-dispersing mixer 50 from being clogged with the impurities. The molten resin composition containing the filler and the resin is allowed to pass through the micro-dispersing mixer 50 to disperse the filler agglomerates in the resin. Since the filler agglomerates that cannot pass through the micro-dispersing mixer are dispersed by convection stirring in the stirring tank, the filler can be dispersed in the resin while preventing clogging by the filler agglomerates. In particular, the stirring tank 55 and the micro-dispersing mixer 50 are directly connected to each other to make it possible to obtain the effect.

According to the micro-dispersing system 51 of the third embodiment, the filler can be dispersed substantially uniformly while the micro-dispersing mixer 50 is prevented from being clogged with impurities.

### Fourth Embodiment

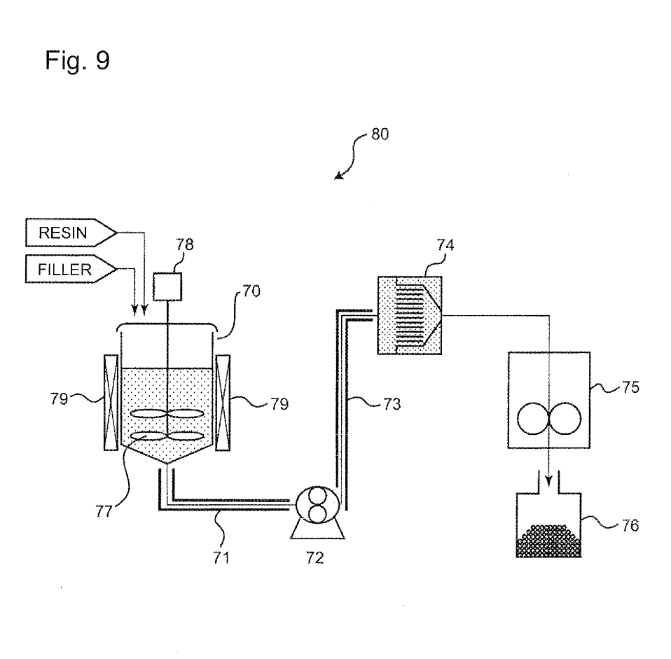

FIG. 9 is a schematic view of a stirring-tank-type pressure micro-dispersing system 80 according to a fourth embodiment. The stirring-tank-type pressure micro-dispersing system 80 includes a stirring tank 70 into which a molten resin composition containing a filler and a resin is injected, a pressurizing means 72 connected to the stirring tank 70 through a pipe 71, a micro-mixing unit 74 connected to the pressurizing means 72 through a pipe 73, a cooling granulation means 75 connected to the micro-mixing unit 74, and a vessel 76 that accepts particles cooled with the cooling granulation means 75. The stirring tank 70 includes a stirring means 77, a drive means 78 connected to the stirring means 77 to enable the stirring means 77 to drive the stirring means 77, and a heating means 79 disposed on the side surface of the stirring tank 70 to heat and melt the resin composition.

In the stirring-tank type pressure micro-dispersing system 80 of the fourth embodiment, a molten resin composition containing a filler and a resin is injected into the stirring tank 70 and stirred by using the stirring means 77 to preliminarily mix the filler in the resin. The molten resin composition is conveyed into the micro-mixing unit 74 while being pressurized with the conveyance means 72. The molten resin composition is allowed to pass through the micro-mixing unit 74 to make it possible to disperse filler agglomerates in the molten resin. Thereafter, the molten resin composition in which the filler is dispersed is cooled, solidified, and ground by the cooling granulation means, which can produce a solidified-particle-like filler-dispersed masterbatch resin.

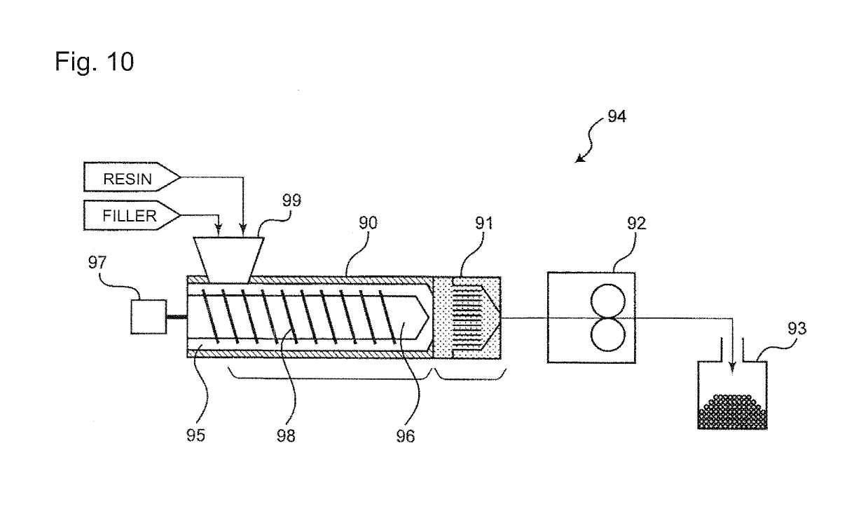

FIG. 10 is a schematic view of an extruding-kneader-type pressure micro-dispersing system 94 according to another aspect of the fourth embodiment. The extruding-kneader-type micro-dispersing system 94 includes an extruding kneader 90 into which a molten resin composition containing a filler and a resin is injected, a micro-mixing unit 91 connected to the extruding kneader 90, a cooling granulation means 92 connected to the micro-mixing unit 91, and a vessel 93 that accepts particles cooled with the cooling granulation means 92. The extruding-kneader 90 includes a kneading path 95 disposed in the extruding kneader 90 in the longitudinal direction, a conveyance means 96 rotatably disposed in the kneading path 95 in parallel with the longitudinal axis thereof, and a drive means 97 connected to the conveyance means 96 to enable the conveyance means 96 to drive. A spiral blade portion 98 is formed on the outer surface of the conveyance means 96, so that the molten resin composition can be conveyed by rotation of the conveyance means 96.

In the extruding-kneader-type pressure micro-dispersing system 94 according to another aspect of the fourth embodiment, the molten resin composition is injected from an injection port 99 of the extruding-kneader 90, the conveyance means 96 is rotated to convey the filler and the resin to the micro-mixing unit 91 while the filler and the resin are preliminarily being mixed with each other. The molten resin composition is allowed to pass through the micro-mixing unit 91, thereby making it possible to disperse filler agglomerates in the molten resin. Thereafter, the molten resin composition in which the filler is dispersed is cooled, solidified, and ground by the cooling granulation means can produce a solidified-particle-like filler-dispersed masterbatch resin.

### Fifth Embodiment

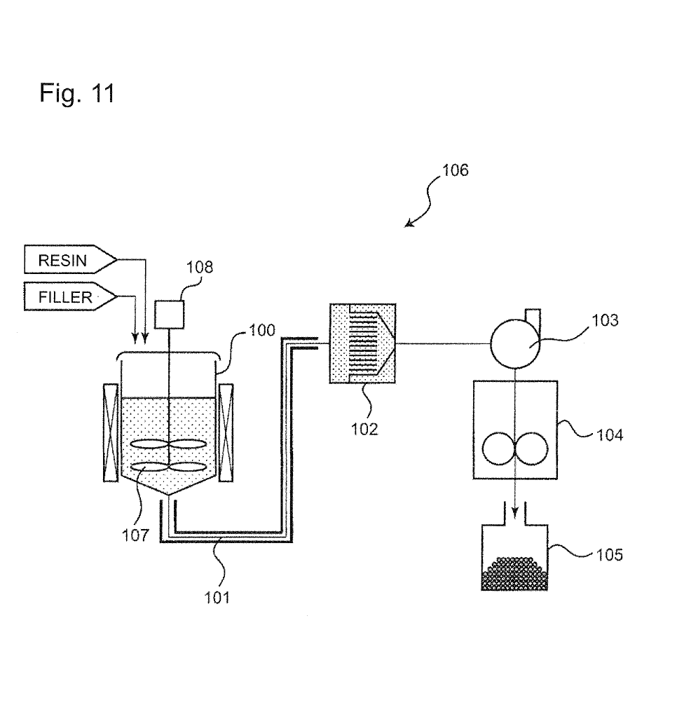

FIG. 11 is a schematic diagram of a stirring-tank-type suction micro-dispersing system 106 according to one aspect of a fifth embodiment. The stirring-tank-type micro-dispersing system 106 includes a stirring tank 100 into which a molten resin composition containing a filler and a resin is injected, a micro-mixing unit 102 connected to the stirring tank 100 through a pipe 101, a suction means 103 connected to the micro-mixing unit 102, a cooling means 104 connected to the suction means 103, and a vessel 105 that accepts cooled particles cooled by the cooling means 104. The stirring tank 100 includes a stirring means 107, a drive means 108 connected to the stirring means 107 to enable the stirring means 107 to drive, and a heating means 108 disposed on the side surface of the stirring tank 100 to cool and melt the resin composition. The suction means 103 may be a suction device such as a vacuum pump.

In the stirring-tank-type micro-dispersing system 106 according to one aspect of the fifth embodiment, a molten resin composition containing a filler and a resin is injected into the stirring tank 100 and stirred by using the stirring means 107 to disperse the filler in the resin. The suction means 103 sucks the molten resin composition in the stirring tank 100, whereby the molten resin composition can be conveyed to the micro-mixing unit 102. The molten resin composition is allowed to pass through the micro-mixing unit 102, so that a partially agglutinating filler can be dispersed (broken) into the resin.

The stirring-tank-type suction micro-dispersing system 106 is adapted to suck the molten resin composition by use of the suction means 103 to put the molten resin composition under a low-pressure condition, and thus can remove gas included in the molten resin composition, that is, enables deaeration.

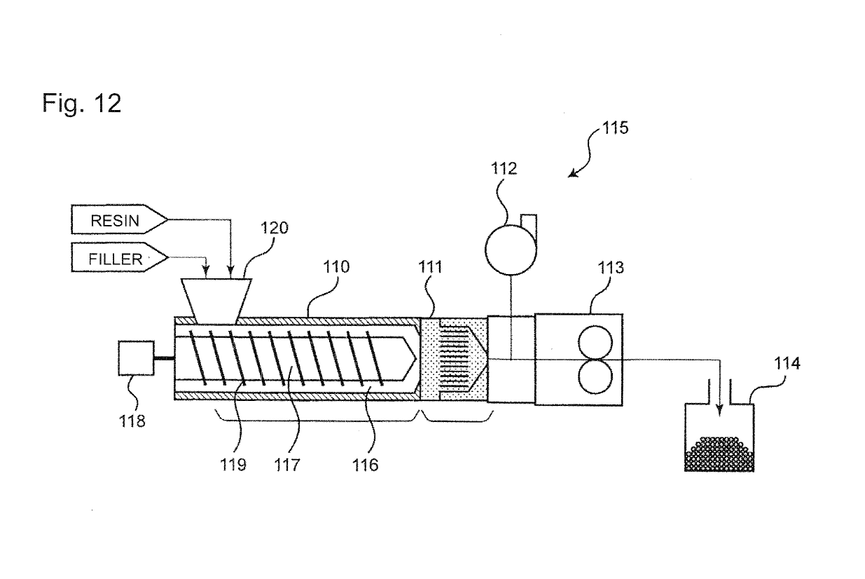

FIG. 12 is a schematic view of an extruding-kneader-type suction micro-dispersing system 115 according to another aspect of the fifth embodiment. The extruding-kneader-type suction micro-dispersing system 115 includes an extruding-kneader 110 into which a molten resin composition containing a filler and a resin is injected, a micro-mixing unit 111 connected to the extruding kneader 110, a suction means 112 connected to the micro-mixing unit 111, a cooling means 113 connected to the suction means 112, and a vessel 114 for accepting cooled particles cooled by the cooling means 113. The extruding-kneader 110 includes a kneading path 116 disposed in the extruding kneader 110 along the longitudinal direction thereof, a conveyance means 117 rotatably disposed in the extruding path 116 in parallel with the longitudinal axis thereof, and a drive means 118 connected to the conveyance means 117 for driving the conveyance means 117. A spiral blade portion 119 is formed on the outer surface of the conveyance means 117, and the conveyance means 117 can rotate to convey the molten resin composition. The suction means 112 may be a suction device, such as a vacuum pump.

In the extruding-kneader-type suction system 115 according to another aspect of the fifth embodiment, a molten resin composition is injected from an injection opening 120 of the extruding-kneader 110, the conveyance means 117 is rotated to disperse the filler in the resin, and the conveyance means 117 applies a pressure to convey the molten resin composition to the micro-mixing unit 111. The suction means 112 sucks the molten resin composition, thereby allowing the molten resin composition to pass through the micro-mixing unit 111. By permitting the molten resin composition to pass through the micro-mixing unit 111, a partially agglomerating filler in the resin can be dispersed (broken).

Accordingly, the extruding-kneader-type suction system 115 in another aspect of the fifth embodiment includes the suction means 112 in addition to the conveyance system 117, and thus can remove gas included in the molten resin composition.

### Sixth Embodiment

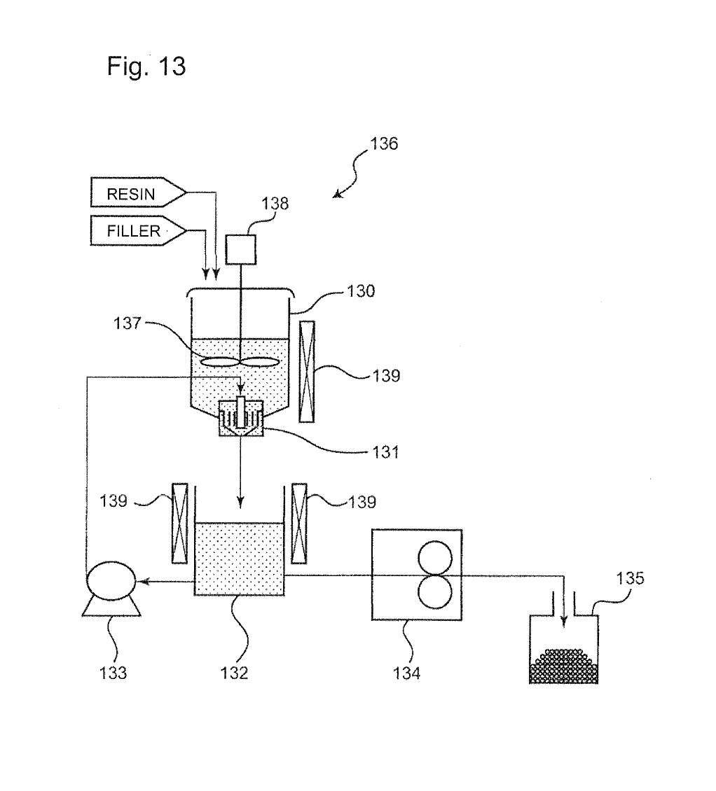

FIG. 13 is a schematic view of a stirring-tank-type self-suction micro-dispersing system 136 according to one aspect of a sixth embodiment. The stirring-tank-type self-suction micro-dispersing system 136 includes a stirring tank 130 into which the molten resin composition containing the filler and the resin is injected and preliminarily mixed together, and a micro-dispersing mixer 131 with a suction flow path connected to the stirring tank 130. The micro-dispersing system 136 also includes a solution receiving tank 132 disposed under the micro-dispersing mixer 131 with a central penetration path, and a conveyance means 133 connected to the solution receiving tank 132 to convey the molten resin composition to the central penetration path of the micro-dispersing mixer 131 with the suction flow path. Further, the micro-dispersing system 136 includes a cooling granulation means 134 connected to the solution receiving tank 132, and a vessel 135 that accepts cooled particles cooled by the cooling granulation means 134. The stirring tank 130 includes a stirring means 137, a drive means 138 connected to the stirring means 137 to enable the stirring means 137 to drive, and a heating means 139 disposed on the side surface of the stirring tank 130 to heat and melt the resin composition. The solution receiving tank 132 includes a heating means 139 disposed on the side surface of the solution receiving tank 132 to heat and melt the resin composition. The conveyance means 133 may be a rotary pump, a reciprocating pump, or the like.

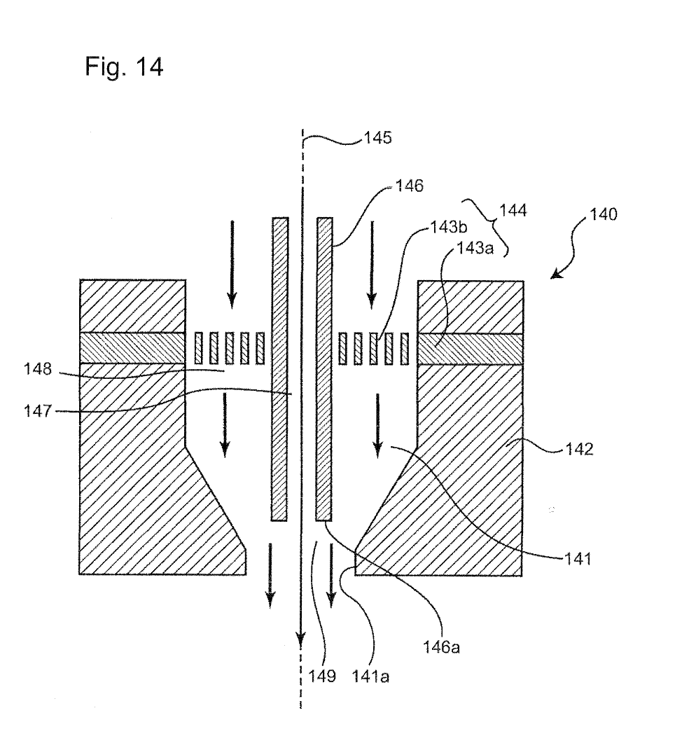

FIG. 14 is a schematic view of a micro-dispersing mixer 140 with a suction flow path. The micro-dispersing mixer 140 having the suction flow path includes a housing 142 in which a main flow path 141 is disposed, a micro-mixing unit 144 disposed in the main flow path 141, and a penetration path 146 formed in the main flow path 141 in substantially parallel to a longitudinal axis 145 of the main flow path 141 to penetrate the micro-mixing unit 144. The micro-mixing unit 144 is configured of a plate-like member 143a with a plurality of fine flow paths 143b penetrating from one major surface to the other major surface of the plate-like member. It is important that a downstream opening end 146a of the penetration path 146 is located on the upstream side of the main flow path 141 with respect to a downstream opening end 141a, and the downstream opening end 141a of the main flow path 141 is reduced in diameter. The molten resin component 147 having passed through the penetration path 146 and flowing at high speed is merged with a molten resin composition 148 having passed through the fine flow paths 143b of the micro-mixing unit 144. With the above structure, the molten resin composition 147 flows at a speed higher than the molten resin composition 148. For this reason, at a merging point 149 between the molten resin composition 147 and the molten resin composition 148, the molten resin composition 147 guides the molten resin composition 148 in the downstream direction at a higher speed, whereby the molten resin composition 148 receives a suction effect.

For example, in the stirring-tank-type self-suction micro-dispersing system 136 in the sixth embodiment shown in FIG. 13, a molten resin composition containing the filler and the resin is injected into the stirring tank 130, and the molten resin composition is stirred by using the stirring means 137 to preliminarily mix the filler and the resin with each other. The molten resin composition is conveyed to the solution receiving tank 132 through the micro-dispersing mixer 131 with a suction flow path disposed under the stirring tank 130. The molten resin composition in the solution receiving tank 132 is conveyed to the suction flow path of the micro-dispersing mixer 131 with the suction flow path and is then allowed to pass through the suction flow path at a high speed so as to attract the molten resin composition in the micro-mixing unit 144 in the flowing direction. The molten resin composition is allowed to pass through the micro-mixing unit 144, thereby making it possible to disperse the filler in the resin.

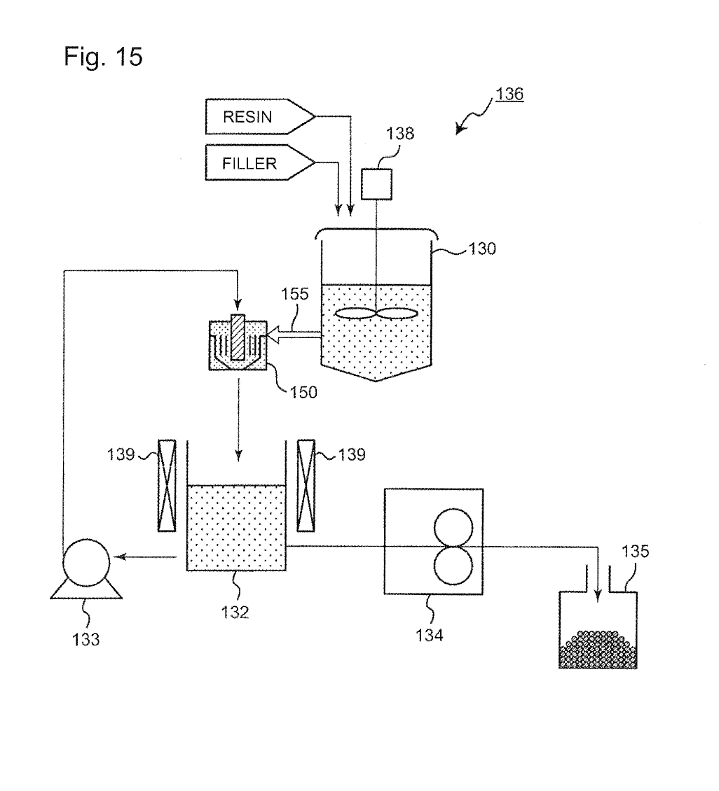

FIG. 15 is a schematic view of the stirring-tank-type self-suction micro-dispersing system 136 according to another aspect of the sixth embodiment. In the one aspect mentioned above, the micro-dispersing mixer 131 having the suction flow path is directly attached to the lower side of the stirring tank 130. Another aspect differs from the above aspect in that the micro-dispersing mixer 131 having the suction flow path is indirectly connected to the stirring tank 130 through a pipe extending from the side surface of the stirring tank 130. With this structure, the micro-dispersing mixer 131 can be prevented from being clogged with impurities.

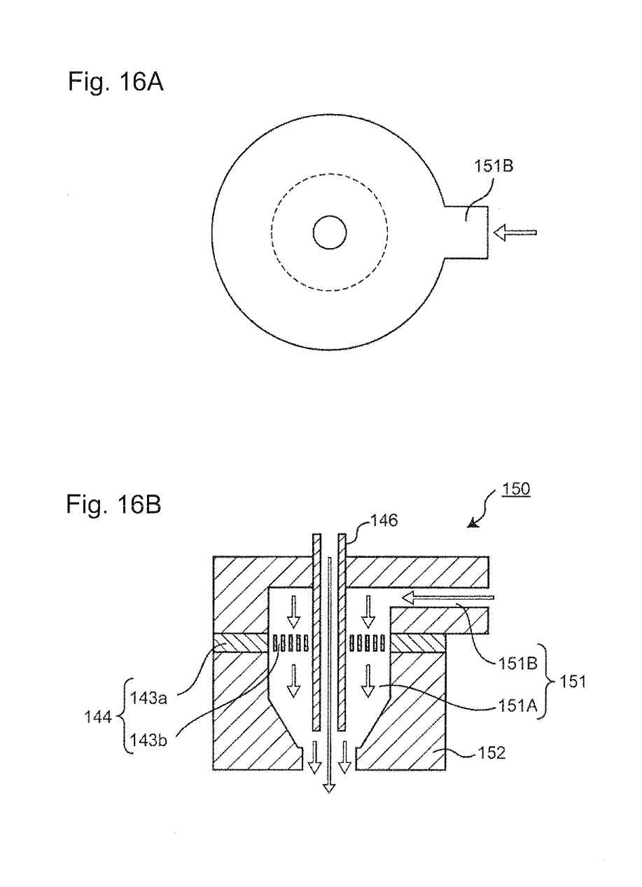

FIG. 16A is an upper view of a micro-dispersing mixer 150 having a suction flow path that is used in the stirring-tank-type self-suction micro-dispersing system 136 according to another aspect, and FIG. 16B is a cross-sectional view of the micro-dispersing mixer 150. The micro-dispersing mixer 150 having the suction flow path is basically the same as the micro-dispersing mixer 140 having the suction flow path. However, in the micro-dispersing mixer 140, the main flow path 141 is linear. In contrast to this, in the micro-dispersing mixer 150, a main flow path 151 is bent in an L-shape.

More specifically, as shown in FIG. 16B, the main flow path 151 includes a flow path 151A disposed in the housing 152 in the longitudinal direction thereof, and a flow path 151B disposed substantially perpendicular to the flow path 151A. A tube 155 extending from the side surface of the stirring tank 130 is connected to the flow path 151B to allow the resin composition to flow to the main flow path 151 through the pipe 155.

In the stirring-tank-type self-suction micro-dispersing system 136 according to another aspect of the sixth embodiment, the micro-dispersing mixer 131 with the suction flow path is connected to the side surface of the stirred tank 130 and not the lower surface thereof, which can prevent the micro-dispersing mixer 131 from being clogged with impurities.

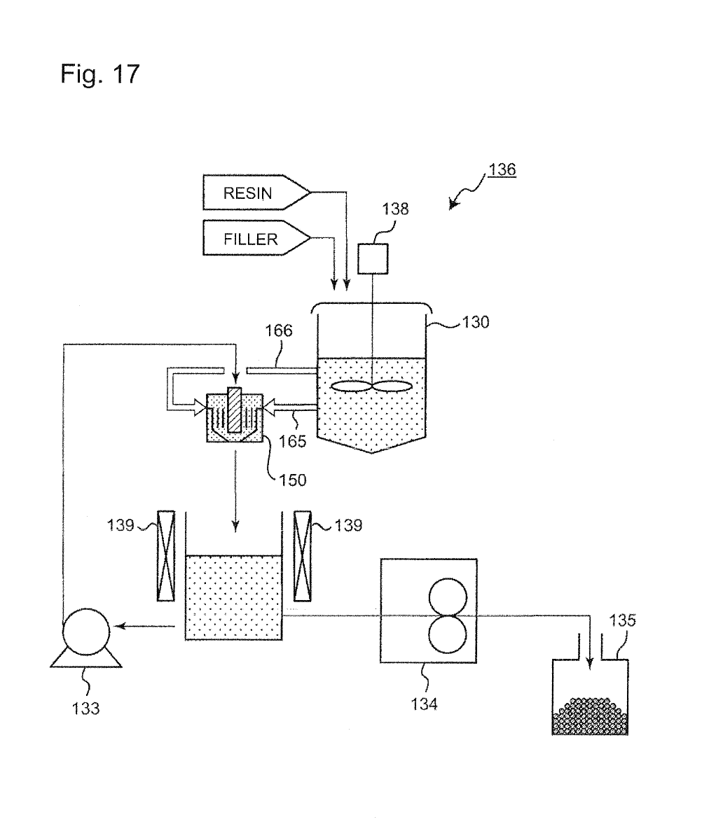

FIG. 17 is a schematic view of the stirring-tank-type self-suction micro-dispersing system 136 according to still another aspect of the sixth embodiment. In another aspect mentioned above, one pipe extends from the side surface of the stirring tank 130. In contrast, in the still another aspect, the two pipes are used. With this arrangement, since an amount of resin composition that can be dispersed is doubled, the dispersive power can be increased.

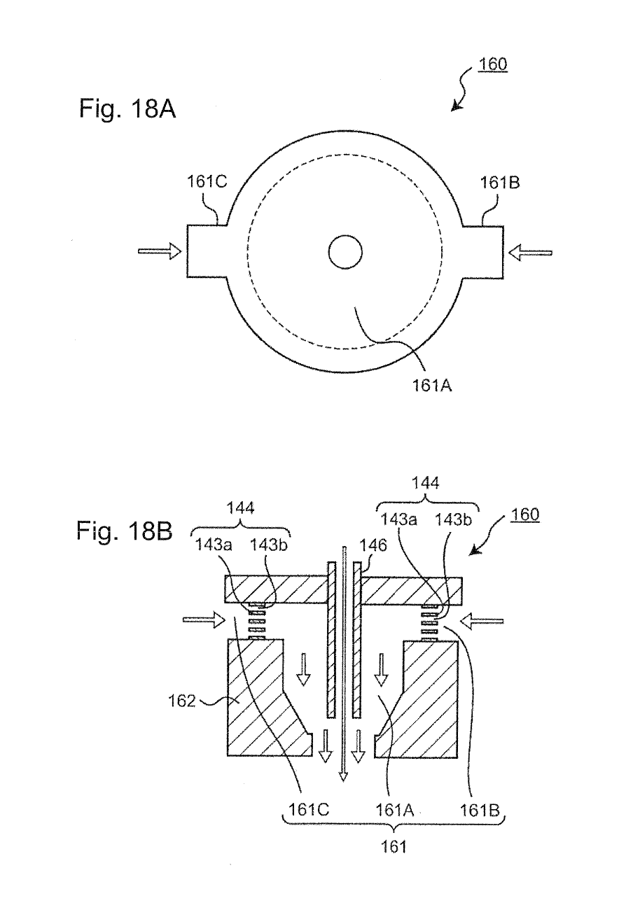

FIG. 18A is an upper view of a micro-dispersing mixer 160 with a suction flow path which is used in the stirring-tank-type self-suction micro-dispersing system 136 according to still another aspect, and FIG. 18B is a sectional view of the micro-dispersing mixer 160. The micro-dispersing mixer 160 with the suction flow path is basically the same as the micro-dispersing mixer 150 with the suction flow path. However, the micro-dispersing mixer 150 in which the main flow path 151 is L-shaped differs from the micro-dispersing mixer 160 in which a main flow path 161 is T-shaped.

More specifically, as shown in FIG. 18B, the main flow path 161 includes a flow path 161A disposed in a housing 162 in the longitudinal direction thereof, a flow path 161B disposed substantially perpendicular to the flow path 161A, and a flow path 161C disposed opposite to the flow path 161B with reference to the flow path 161A. Two pipes 165 and 166 extending from the side surface of the stirring tank 130 are connected to the flow path 161B and the flow path 161C, respectively, to circulate the resin composition in the main flow path 161 through the two pipes 165 and 166.

In the stirring-tank-type self-suction micro-dispersing system 136 according to the further aspect of the sixth embodiment, since the micro-dispersing mixer 131 with a suction flow path is connected to the stirring tank 130 through the two pipes 165 and 166, the amount of resin composition that can be dispersed is doubled, and the dispersive power can be increased.

In the stirring-tank-type self-suction micro-dispersing system 136 according to the sixth embodiment, suction can be easily executed at low cost because an additional device such as a suction pump is not used.

### Seventh Embodiment

In a method for producing a filler-dispersed molten resin composition according to a seventh embodiment, a resin composition containing filler aggregates and a molten resin composition is preliminarily mixed by a mixing means, and thereafter, the preliminarily mixed mixture is allowed to pass through the above-mentioned micro-dispersing mixer with the fine flow paths to break the filler aggregates and to disperse the filler in the resin composition.

For example, carbon black used as a filler forms primary aggregates each having several micrometers obtained by agglutinating primary particles having diameters of 10 to 50 nm, and some primary aggregates are combined to each other to form a secondary aggregate having a size of several 100 μm or less. In general, when secondary aggregates are preliminary mixed, the dispersion easily progresses from the secondary aggregates to primary aggregates with shearing flow. However, thereafter, a greater deal of energy is required. On the other hand, when the secondary aggregates are dispersed with the micro-dispersing mixer, primary aggregates can be easily broken into primary particles with elongational flow. In contrast, it takes considerably much time to break from the secondary aggregates into the primary aggregates. In addition, since the secondary aggregates are difficult to pass through the micro-dispersing mixer, the micro-dispersing mixer is more likely to be clogged.

In the method for producing a filler-dispersed molten resin composition according to the seventh embodiment, filler aggregates are dispersed in the molten resin composition by preliminary mixing, and, thereafter, the preliminarily mixed mixture is supplied to the micro-dispersing mixer to make it possible to suppress energy required for filler dispersion, to drastically shorten a kneading time, and to prevent the micro-dispersing mixer from being clogged.

### Example

The present invention will be described below by way of examples but the present invention is not limited by these examples.

### [Preliminarily Mixed Material]

Ten parts by weight of carbon black (Mitsubishi Chemical Corporation: MA600) and 90 parts by weight of silicone oil (Shin-Etsu Chemical Co., Ltd.: KF-96-30CS) were put in a stirring tank 170 and preliminarily mixed together while being stirred by a turbine stirring blade. Some of the mixture was sampled, and then an average particle diameter of the carbon black of the sample was measured by a dynamic light scattering method (Malvern Instruments Ltd: Zetasizer Nano ZS) and determined to be 1240 nm as a result.

### [System]

As shown in FIG. 19, the stirring tank 170, a tube pump 171, and a micro-dispersing mixer 172 were connected in series in the order by a pipe 174 to thereby configure a system 175 in which liquid could be received with a liquid receiving tank 173. Some of fluid discharged from the micro-dispersing mixer 172 was sampled, and then an average particle diameter of carbon black of the sample was measured in the same method as that for the preliminarily mixed material.

### [Micro-Dispersing Mixer]

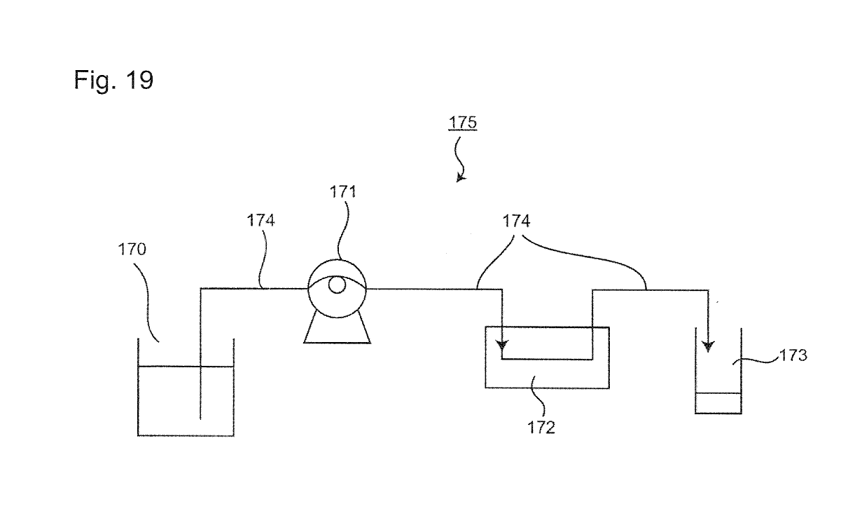

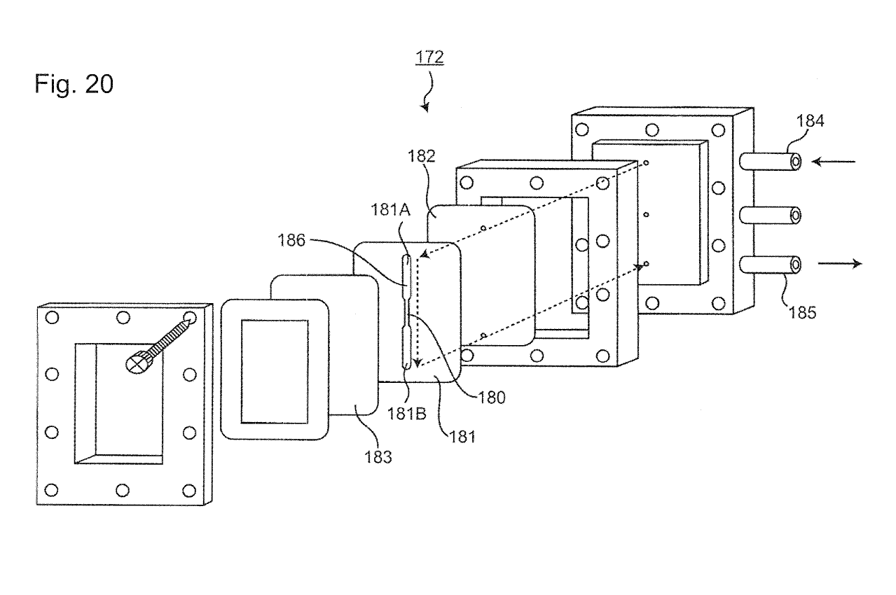

A micro-dispersing mixer 172 was produced as shown in FIG. 20 by using a plate 181 with a fine flow path 180. The fine flow path plate 181 with through holes having various shapes was produced, and the fine flow path plate 181 was sandwiched between a guide plate 182 and a glass plate 183 to form the micro-dispersing mixer 172. The one or two guide plates 182 were formed such that the fine flow path plate 181 could be in fluid communication with a suction port 184 and a discharge port 185 of the micro-dispersing mixer 172.

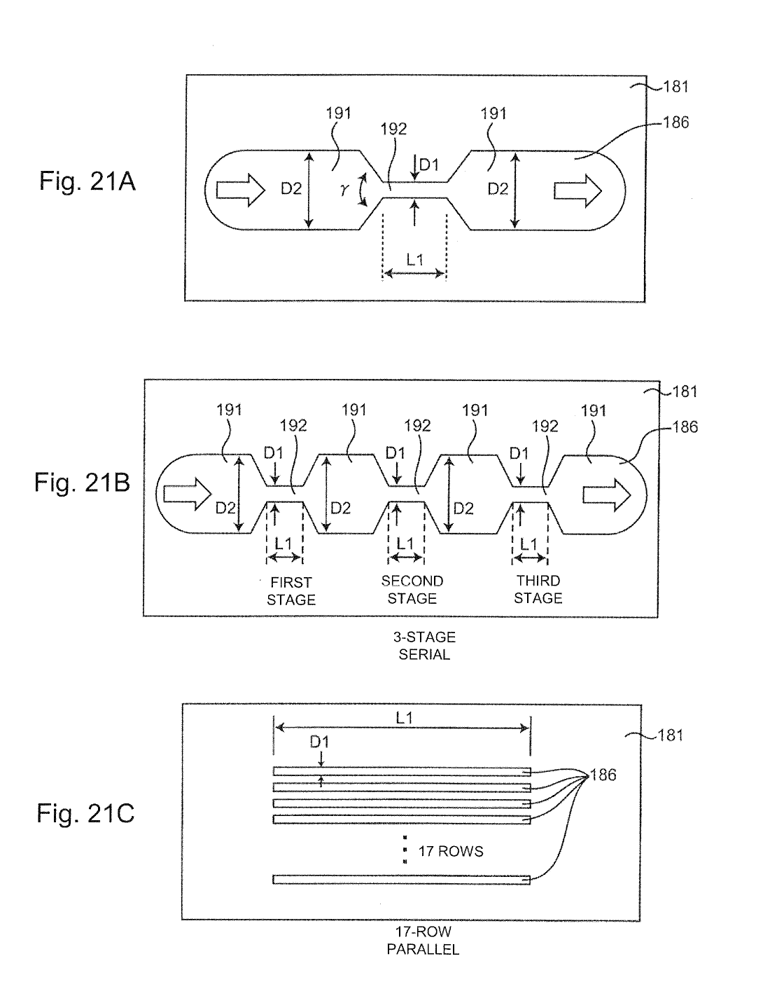

The shapes of the through holes 186 in the fine flow path plates 181 are as shown in FIGS. 21A to 21C and Table 1. The fine flow path plate 181 was configured such that a suction port side 181A and a discharge port side 181B were symmetrical. In fine flow path plates (1) to (7) shown in Table 1, an introduction angle γ from a main flow path 191 to a fine flow path 192 was set to 120°.

TABLE 1

| | Thick- | Fine flow | Main flow | Main flow | |
|---|---|---|---|---|---|
| | ness | path width | path length | path width | |
| | t (mm) | D1 (mm) | L1 (mm) | D2 (mm) | Remarks |
| Fine flow | 0.2 | 0.2 | 30 | 4 | |
| path plate (1) | | | | | |
| Fine flow | 0.8 | 0.8 | 30 | 4 | |
| path plate (2) | | | | | |
| Fine flow | 1.6 | 1.6 | 30 | 4 | |
| path plate (3) | | | | | |
| Fine flow | 3.2 | 3.2 | 30 | 4 | |
| path plate (4) | | | | | |
| Fine flow | 0.8 | 0.8 | 2 | 4 | |
| path plate (5) | | | | | |
| Fine flow | 0.8 | 0.8 | 2 | 4 | 3-stage |
| path plate (6) | | | | | serial |
| Fine flow | 0.2 | 0.2 | 38 | — | 17-row |
| path plate (7) | | | | | parallel |
| Fine flow | 0.8 | 0.8 | 38 | — | 17-row |
| path plate (8) | | | | | parallel |

### Comparative Example 1

A fine flow path plate (1) was disposed in the micro-dispersing mixer 172 shown in FIG. 20, and a resultant structure was disposed in the system 175 shown in FIG. 19. At first, only silicone oil was circulated at a mass flow rate of 0.1 g/s, and it was confirmed that the silicone oil flowed. When the silicone oil was switched to a material preliminarily mixed and the mixed material was supplied, a pressure loss increased, and the tube pump 171 was idled to make it impossible to circulate the material.

### Example 1

A fine flow path plate (2) was disposed in the same manner as mentioned above, and it was confirmed that circulation of only the silicone oil could be performed. Thereafter, the silicone oil was switched to the material preliminarily mixed, and the material was supplied at a mass flow rate of 0.2 g/s. After a predetermined period of time elapsed, a part of a fluid discharged from the micro-dispersing mixer 172 was sampled, and then an average particle diameter of carbon black of the sample was measured and determined to be 518 nm as a result. It was confirmed that aggregates were broken and dispersed in the resin.

### Comparative Example 2

A fine flow path plate (3) was disposed in the same manner as mentioned above, and it was confirmed that circulation of only the silicone oil could be performed. Thereafter, the silicone oil was switched to the material preliminarily mixed, and the mixed material was supplied at a mass flow rate of 0.2 g/s. After a predetermined period of time elapsed, a part of fluid discharged from the micro-dispersing mixer 172 was sampled, and then an average particle diameter of carbon black was measured and determined to be 817 nm.

### Example 2

The fine flow path plate (3) was disposed by the same manner as mentioned above, and it was confirmed that circulation of only the silicone oil could be performed. Thereafter, the silicone oil was switched to the material preliminarily mixed, and the mixed material was supplied at a mass flow rate of 1.1 g/s. After a predetermined period of time elapsed, a part of a fluid discharged from the micro-dispersing mixer 172 was sampled, and an average particle diameter of carbon black was measured and determined to be 540 nm.

### Comparative Example 3

A fine flow path plate (4) was disposed by the same manner as mentioned above, and it was confirmed that circulation of only the silicone oil could be performed. Thereafter, the silicone oil was switched to the material preliminarily mixed, and the mixed material was supplied at a mass flow rate of 1.1 g/s. After a predetermined period of time elapsed, a part of fluid discharged from the micro-dispersing mixer 172 was sampled, and then an average particle diameter of carbon black of the sample was measured and determined to be 1150 nm.

As shown in Examples 1 and 2 and Comparative Examples 2 and 3, as a fine flow path width is increased, a dispersing effect is decreased. However, the increase in flow rate enables the dispersion.

### Comparative Example 4

A fine flow path plate (5) was disposed by the same manner as mentioned above, and it was confirmed that circulation of only the silicone oil could be performed. Thereafter, the silicone oil was switched to the material preliminarily mixed, and the mixed material was supplied at a mass flow rate of 0.2 g/s. After a predetermined period of time elapsed, a part of a fluid discharged from the micro-dispersing mixer 172 was sampled, and an average particle diameter of carbon black of the sample was measured and determined to be 992 nm.

### Example 3

A fine flow path plate (6) was disposed by the same manner as mentioned above, and it was confirmed that circulation of only the silicone oil could be performed. Thereafter, the silicone oil was switched to the material to be preliminarily mixed, and the mixed material was supplied at a mass flow rate of 0.2 g/s. After a predetermined period of time elapsed, a part of fluid discharged from the micro-dispersing mixer 172 was sampled, and an average particle diameter of carbon black of the sample was measured and determined to be 314 nm.

As shown in Examples 1 and 3 and Comparative Example 4, when the length of the fine flow path is decreased, a dispersing effect is reduced. However, even though the fine flow path length is short, repetitive circulation is performed through the fine flow path 192 and the enlarged flow path 191, which enables the dispersion.

### Example 4

A fine flow path plate (7) was disposed in the same manner as mentioned above, and it was confirmed that circulation of only the silicone oil could be performed. Thereafter, the silicone oil was switched to the material preliminarily mixed, and the mixed material was supplied at a mass flow rate of 1.1 g/s. After a predetermined period of time elapsed, a part of fluid discharged from the micro-dispersing mixer 172 was sampled, and an average particle diameter of carbon black was measured and determined to be 240 nm.

### Example 5

A fine flow path plate (8) was disposed in the same manner as mentioned above, and it was confirmed that circulation of only the silicone oil could be performed. Thereafter, the silicone oil was switched to the material preliminarily mixed, and the material was supplied at a mass flow rate of 1.1 g/s. After a predetermined period of time elapsed, a part of fluid discharged from the micro-dispersing mixer 172 was sampled, and an average particle diameter of carbon black of the sample was measured and determined to be 675 nm.

As shown in Example 4 and Comparative Example 1, when a fine flow path width becomes small, the flow path may be clogged. However, the fine flow paths are disposed in parallel with each other, which makes it possible to suppress the fine flow paths from being clogged.

As shown in Example 5, since the fine flow paths are disposed in parallel with each other to reduce a flow rate of a fluid flowing in each of the fine flow paths, the dispersing effect is slightly reduced. However, when the mass flow rate is increased to speed up the flow rate of the fluid flowing in each fine flow path, the dispersing effect is increased. Therefore, high-flow processing can be industrially expected.

| | | | Average |
|---|---|---|---|
| | | Mass flow | particle |
| | | rate | diameter |
| | | (g/s) | (nm) |
| Comparative | Fine flow path plate | 0.2 | — |
| Example 1 | (1) | | |
| Example 1 | Fine flow path plate | 0.2 | 518 |
| | (2) | | |
| Comparative | Fine flow path plate | 0.2 | 817 |
| Example 2 | (3) | | |
| Example 2 | Fine flow path plate | 1.1 | 540 |
| | (3) | | |
| Comparative | Fine flow path plate | 1.1 | 1,150 |
| Example 3 | (4) | | |
| Comparative | Fine flow path plate | 0.2 | 992 |
| Example 4 | (5) | | |
| Example 3 | Fine flow path plate | 0.2 | 314 |
| | (6) | | |
| Example 4 | Fine flow path plate | 1.1 | 240 |
| | (7) | | |
| Example 5 | Fine flow path plate | 1.1 | 675 |
| | (8) | | |

*Average particle diameter of carbon black in material preliminarily mixed: 1,240 nm

### DESCRIPTION OF REFERENCE NUMERAL

1, 21, 31 Micro-dispersing mixer
2 Main flow path
3a Plate-like member
3b Fine flow path
4 Micro-mixing unit

1. A method for producing a filler-dispersed molten resin composition by dispersing a filler in a molten resin composition, the method comprising the steps of:
preliminarily mixing a resin composition by a mixing unit, the resin composition containing filler aggregates and molten resin composition; and
allowing a preliminarily mixed mixture to pass through a micro-dispersing mixer having a fine flow path to break the filler aggregates and to disperse the filler in the resin composition.

2. The method for producing a filler-dispersed molten resin composition according to claim 1, wherein the filler is at least one selected from the group consisting of carbon black and carbon nanotube.

3. The method for producing a filler-dispersed molten resin composition according to claim 1, wherein the molten resin is a thermosetting resin in a state before being cured.

4. The method for producing a filler-dispersed molten resin composition according to claim 3, wherein the thermosetting resin is at least one selected from the group consisting of an epoxy resin, a phenol resin, a melamine resin, a urea resin, an unsaturated polyester resin and a thermosetting elastomer.

5. The method for producing a filler-dispersed molten resin composition according to claim 1, wherein the molten resin is at least one selected from the group consisting of a thermoplastic resin and a thermoplastic elastomer.

6. A filler-dispersed masterbatch resin produced by cooling and solidifying a filler-dispersed molten resin composition prepared by the method for producing a filler-dispersed molten resin composition according to claim 5.

7. A method for producing a filler-dispersed masterbatch resin comprising a filler and a resin by cooling and solidifying a filler-dispersed molten resin composition prepared by the method according to claim 1.

8. A method for producing a sealing resin composition produced by supplying a filler-dispersed molten resin composition produced by the method according to claim 1.

9. A micro-dispersing mixer for dispersing a filler in a molten resin composition, comprising:
a main flow path allowing a mixture comprising a filler and a molten resin composition to pass through the main flow path; and
a micro-mixing unit disposed in the main flow path, the micro-mixing unit having at least one fine flow path, and adapted to break filler aggregates,
wherein the mixture is allowed to pass through the fine flow path.

10. The micro-dispersing mixer according to claim 9, further comprising:
a sub-flow path having a suction port and a discharge port communicating with the suction port, the suction port being disposed near an upstream of the micro-mixing unit, and the discharge port being in fluid communication with the main flow path on an upstream side of the main flow path with respect to the suction port,
wherein a part of the mixture is allowed to flow through the fine flow path, and the remaining part of the mixture is refluxed to the upstream of the main flow path through the sub-flow path.

11. The micro-dispersing mixer according to claim 10, further comprising:
a suction unit disposed on the downstream of the micro-mixing unit in the main flow path, the suction unit being adapted to suck the molten resin composition, or
a pressurizing unit disposed on the upstream of the micro-mixing unit in the main flow path, the pressurizing unit being adapted to pressurize the molten resin composition, or
both the units.

12. The micro-dispersing mixer according to claim 11, wherein the suction unit is a penetration path disposed in the main flow path to penetrate the micro-mixing unit in substantially parallel with the main flow path, and a downstream side opening end of the penetration path is located on the upstream side of the main flow path with respect to a downstream side opening end of the main flow path.

13. The micro-dispersing mixer according to claim 9, wherein the main flow path further comprises a projection extending from an inner wall of the main flow path toward a center thereof so as to go around the inner wall.

14. A micro-dispersing system comprising:
the micro-dispersing mixer according to claim 9; and
a stirring tank connected to an upstream opening end of the main flow path,
wherein the stirring tank comprises a stirring unit for stirring a molten resin composition in the stirring tank and conveying the molten resin composition to the micro-mixing unit in the main flow path.

15. The micro-dispersing system according to claim 14, wherein the stirring tank further comprises a convection passage disposed near an inlet of the main flow path.

16. The micro-dispersing system according to claim 14, further comprising a kneading unit disposed on the upstream of the main flow path.

17. The micro-dispersing system according to claim 16, wherein the kneading unit is a screw extruding kneader, a batch internal mixer, or a continuous single or twin screw extruding kneader.

18. A method for producing a sealing resin composition produced by using a filler-dispersed masterbatch resin produced by the method for producing a filler-dispersed masterbatch resin according to claim 6.
